(19) United States
(12) Patent Application Publication
(10) Pub. No.: US 2018/0252254 A1
(43) Pub. Date: Sep. 6, 2018

(54) DRILLING SCREW

(71) Applicant: EJOT BAUBEFESTIGUNGEN GMBH, BAD LAASPHE (DE)

(72) Inventor: Tobias Kettner, Erndtebrück-Birkelbach (DE)

(73) Assignee: EJOT BAUBEFESTIGUNGEN GMBH, BAD LAASPHE (DE)

(21) Appl. No.: 15/755,678

(22) PCT Filed: Aug. 27, 2015
(86) PCT No.: PCT/EP2015/069658

§ 371 Date: Mar. 23, 2018

(51) Int. Cl. F16B 25/00; F16B 25/10

(52) U.S. Cl. CPC F16B 25/0094; F16B 25/103

(57) ABSTRACT

A drilling screw, particularly a two-component steel screw, having a head part and a cutting part, wherein the head part is made of a corrosion-resistant material and comprises a screw head and a shank section, and wherein the cutting part is made of a hardenable material, a cemented carbide, or a technical ceramic, characterized in that an intermediate section made of a corrosion-resistant material is disposed between the shank section and the cutting part, which intermediate section is non-releasably connected to the shank section, wherein the cutting part comprises a peg-like projection or a cup-like recess and wherein the intermediate section comprises a cup-like recess or a peg-like projection, wherein the cup-like recess or a peg-like projection has an engagement profile with multiple engagement sections in its cross section, wherein said peg-like projection is disposed in the cup-like recess and wherein said intermediate section is permanently connected to the cutting part by means of impact extrusion, such that the peg-like projection of the cutting part axially undercuts at least sections of the intermediate section in the region of the cup-like recess or such that the peg-like projection of the intermediate section axially undercuts at least sections of the cutting part in the region of the cup-like recess.

### BACKGROUND OF THE INVENTION

The invention relates to a drilling screw, particularly a two-component steel screw, having a head part and a cutting part, wherein the head part is made of a corrosion-resistant material and comprises a screw head and a shank section and wherein the cutting part is made of a hardenable or hard material.

The invention further relates to a method for manufacturing a drilling screw, particularly a two-component steel screw, comprising a head part made of a corrosion-resistant material and having a screw head and a shank section, a cutting part made of a hardenable or hard material, and an intermediate section made of a corrosion-resistant material and disposed between the shank section and the cutting part.

Drilling screws or two-component steel screws, as well as methods for manufacturing such drilling or two-component steel screws, are widely known from prior art. The use of two-component steel screws, which comprise a stainless head part for the outside of a building to prevent exposure of said head part to corrosion or rust, respectively, is particularly common in building engineering. Furthermore, the two-component steel screws known from prior art comprise a hardened portion with a steel drill tip on the cutting part, such that, on the one hand, a stainless outer side of the two-component steel screw that is exposed to the weather can be provided whereas the hardened front portion provides a drill tip.

It is known from prior art that the head part and the cutting part can be connected by gluing, welding, or screwing the two parts together. Both the head part and the cutting part can comprise a female thread, and the two parts can be connected using a threaded pin.

But the two-component steel screws known from prior art have shown that the head part and the cutting part cannot always be reliably connected. Furthermore, producing a thread on the shank of a two-component steel screw requires that the head part and the cutting part are flush with one another. High variation is found in practice here as well. Consequently, the two-component steel screws known from prior art and methods for manufacturing such two-component steel screws result in high reject rates and a high testing workload. It is known from the postpublished German patent application DE 10 2014 204 598 that a cutting part and a head part can be connected by impact extrusion. But this also showed that particularly long screws cannot be manufactured as described there.

### SUMMARY OF THE INVENTION

It is therefore the object of the invention to provide a drilling screw, particularly a two-component steel screw, and a method for manufacturing a drilling or two-component steel screw, wherein the problems mentioned are avoided.

The object mentioned above is achieved by a drilling screw having the features of claim 1. Other advantageous embodiments of the two-component steel screw can be derived from the dependent claims. According to the invention, an intermediate section made of a corrosion-resistant material is disposed between the shank section and the cutting part, which intermediate section is non-releasably connected to the shank section, wherein the cutting part comprises a peg-like projection or a cup-like recess and wherein the intermediate section comprises a cup-like recess or a peg-like projection, wherein one of the two parts to be connected has an engagement profile in its cross section, wherein said peg-like projection is disposed in the cup-like recess and wherein said intermediate section is permanently connected to the cutting part by means of impact extrusion such that the peg-like projection of the cutting part axially undercuts at least sections of the intermediate section in the region of the cup-like recess or such that the peg-like projection of the intermediate section axially undercuts at least sections of the cutting part in the region of the cup-like recess. If the cutting part is connected to the intermediate section and the intermediate section is non-releasably connected to the head part in the region of the shank section—for example by welding—the shank section, the intermediate section, and the cutting part jointly form the screw shank. A thread, for example, can then be applied to the screw shank.

The head part and the intermediate section are preferably made of stainless steel, whereas the cutting part is preferably made of heat-treated steel, a HSS, a cemented carbide, or a technical ceramic. It is particularly preferred that the head part is connected to the cutting part using a lateral extrusion process. An undercut according to the invention can particularly be achieved by means of a lateral extrusion process, wherein the material flows transversely to the operating direction of a pressing machine.

Since a relatively short intermediate section can be used for impact extrusion, a secure connection of cutting part and intermediate section can be achieved on the one hand, wherein on the other hand a reliable non-releasable connection between the intermediate section and the head part can be produced, since their materials are of the same type. The screw length can then preferably be defined by defining the length of the shank section of the head part.

Advantageously, the engagement sections extend radially inwards in the cup-like recess or on the peg. The impact extrusion process or lateral extrusion process can provide an undercut between the cutting part and the intermediate section or between the peg-like projection and the cup-like recess, respectively, such that the intermediate section and the cutting part are securely connected in the axial direction, i.e. in the direction of the longitudinal axis of the screw.

Providing an engagement profile with the engagement sections also allows torque transmission from the head part to the cutting part. Thus, the head part and the cutting part of a drilling screw according to the invention can be reliably and easily connected both in the axial and the radial directions.

Advantageously, the cup-like recess and the peg-like projection are each disposed on a front side of the head part or cutting part, respectively, which front side is disposed perpendicular to a central longitudinal axis of the screw.

It is further particularly preferred that the peg-like projection completely fills the cup-like recess or the intermediate part completely encompasses the peg-like projection. Thus, a positive locking connection can be provided between the intermediate section and the cutting part in a drilling screw according to the invention.

It is further advantageous that the cutting part is hardened, particularly case hardened, and comprises a drill tip.

It is particularly preferred that the cutting part comprises a core hole which leads into the drill tip. Such a drill tip can be used as a lubricant reservoir during operation of the drilling screw, i.e. when screwing it, for example, into a plate girder.

The cutting part is advantageously made of a high-speed steel (HSS), a high-alloy or carbon steel, a cemented carbide, or a technical ceramic.

It is particularly preferred that the head part and the intermediate section are made of a stainless steel. Advantageously, the head part and the intermediate section are made of the same stainless steel, such that the head part and the intermediate section can easily and reliably be non-releasably connected.

In another advantageous embodiment of the drilling screw, the engagement profile is designed as a Torx, Torx plus, hexagon, multi-tooth, gearing, or cross.

In another advantageous embodiment of the drilling screw, circular segments are provided between the engagement sections. Advantageously, the engagement profile has three engagement sections. Consequently, the engagement profile with its three engagement sections also includes three circular segments. The circular segments can advantageously dispose radially outside on the engagement sections in the cup-like recess or on the peg-like projection.

It is further advantageous that the engagement sections and the circular segments are disposed in the circumference of the cup-like recess or on the peg-like projection at an angle of about 120 degrees.

In another advantageous embodiment of the two-component steel screw the cup-like recess or the peg-like projection have a first radius in the region of the circular segments and a second, decreasing radius, which is smaller than the first radius, in the region of the engagement sections. Particularly, the engagement sections can be designed as inverse circular segments which extend radially inwards towards the center of the recess.

The object mentioned at the outset is also achieved by a method for manufacturing a two-component steel screw having the features of claim 8. Such a method includes the following steps: Pressing a cup-like recess of a predetermined depth into the intermediate section or molding a peg-like projection of a predetermined length onto the intermediate section; Producing the cutting part having a peg-like projection of a length which is greater than the depth of the recess, or pressing a cup-like recess into the cutting part, said recess having a length that is smaller than the length of the peg-like projection of the intermediate section, wherein an engagement profile with engagement sections is pressed in when pressing in the cup-like recess; Inserting the projection into the recess and connecting the intermediate section and the cutting part by means of impact extrusion, such that the peg-like projection completely molds into the cup-like recess; Welding together the shank section and the intermediate section which is connected to the cutting part. It is particularly preferred that a lateral extrusion process is used as impact extrusion process.

The object mentioned at the outset is also achieved by a method for manufacturing a two-component steel screw having the features of claim 8. Such a method includes the following steps: Pressing a cup-like recess of a predetermined depth into the intermediate section or molding a peg-like projection of a predetermined length onto the intermediate section; Producing the cutting part having a peg-like projection or a cup-like recess with an engagement profile in its cross section; Inserting the projection into the recess and connecting the intermediate section and the cutting part by means of impact extrusion, such that the peg-like projection completely fills out the cup-like recess or the peg-like projection is completely encompassed; non-releasably connecting the shank section and the intermediate section which is connected to the cutting part. It is particularly preferred that a lateral extrusion process is used as impact extrusion process.

When producing the cutting part, it can advantageous be impact or cup extruded at a maximum extrusion ratio of 75%. After connecting, that is, when the peg-like projection has completely fills out the cup-like recess or is completely encompassed, it is particularly preferred that the peg-like projection undercuts at least sections of the cup-like recess. Since the peg-like projection has a length that is greater than the depth of the cup-like recess prior to connecting, the material of the cutting part can deflect in the radial direction into the cup-like recess during the axial displacement in the extrusion process. In this way, belly-shaped sections which extend radially outwards can be produced on the peg-like projection of a completely connected screw. These belly-shaped projections can be used to provide the undercut, whereby the head part is securely and positively connected to the cutting part in the axial direction. Furthermore, an undercut may already be attached to the peg-like projection or in the cup-like recess, such that the material of the intermediate part abuts against the peg-like projection or the wall of the cup-like recess and thus produces a positive locking axial connection.

In an advantageous further development of the method, the cup-like recess is pressed into the intermediate section or into the cutting part at an area ratio of about 20% to about 75% relative to the cross-sectional area of the intermediate section. It turned out that a particularly reliable connection of the intermediate section and the cutting part can be provided at such an area ratio.

It is further advantageous that the peg-like projection is produced in a circular cylindrical shape when producing the cutting part. Advantageously, the circumferential surface of the projection is smooth. The diameter of the circular cylindrical projection is preferably selected such that it is smaller than, or equal to, the smallest inner diameter of the cup-like recess. Thus, the projection can simply be inserted into the cup-like recess before the extrusion process starts.

In the method according to the invention, an engagement profile with engagement sections is pressed into the intermediate part during pressing into the cup-like recess. It is particularly preferred that the engagement sections extend radially inwards, such that these can be used for improving torque transmission between the head part and the cutting part after connecting by impact extrusion.

In the method according to the invention, an engagement profile with engagement sections is also attached to the cutting part during impact extrusion of the peg-like projection. It is particularly preferred that the engagement sections extend radially inwards, such that these can be used for improving torque transmission between the head part and the cutting part after connecting by impact extrusion.

In another advantageous further development of the method, the intermediate section and the cutting part are arranged in axial alignment prior to connecting. This can involve that the intermediate section and the cutting part are brought into alignment in an extrusion die by the extrusion die.

It is further advantageous that the shank section and the intermediate section which is connected to the cutting part are brought into axial alignment prior to being welded together.

It is particularly preferred that the shank section, the intermediate section, and the cutting part are rolled straight after welding and a thread is then rolled onto the shank section, the intermediate section, and the cutting part. It is particularly preferred that the process of thread rolling further improves the connection between the head part and the cutting part.

It is further advantageous that manufacturing the cutting part or intermediate part and connecting with that of the two components are performed in a multi-stage press.

### BRIEF DESCRIPTION OF THE DRAWINGS

Further details and advantageous further developments of the invention can be derived from the description below, in which the embodiments of the invention shown in the figures are described and explained in more detail.

Wherein:

FIG. 1 shows a drilling screw according to the invention;

FIG. 2 shows an intermediate section for the drilling screw according to FIG. 1;

FIG. 3 shows a cutting part for the drilling screw according to FIG. 1;

FIG. 4 shows an intermediate section and cutting part of the drilling screw according to FIG. 1 in flush alignment prior to an impact extrusion process;

FIG. 5 shows a detailed view of an intermediate section and a cutting part at the beginning of an impact extrusion process;

FIG. 6 shows a detailed view of an impact extruded connection after an impact extrusion process;

FIG. 7 shows a cup-like recess of the intermediate section according to FIG. 2; and

FIGS. 8 to 13 show further detailed views of embodiments according to the invention.

### DETAILED DESCRIPTION

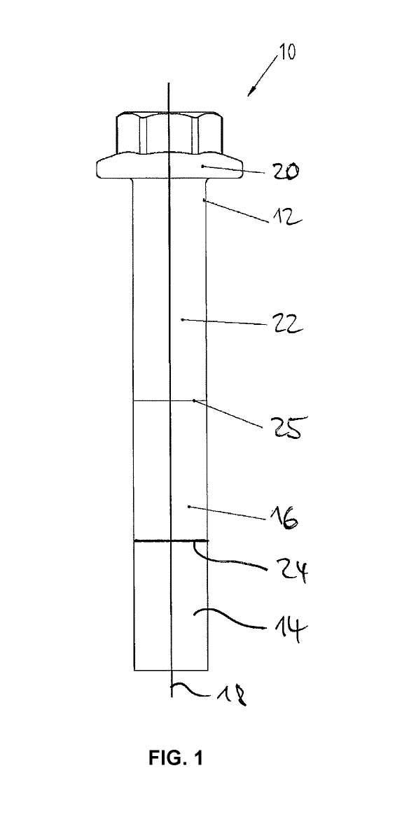

FIG. 1 shows a drilling screw 10 designed as a two-component steel screw, wherein the drilling screw 10 comprises a head part 12 and a cutting part 14. An intermediate section 16 is disposed in axial alignment with a central longitudinal axis 18 of the drilling screw between the head part 12 and the cutting part 14. The head part 12 further comprises a screw head 20 and a shank section 22. The intermediate section 16 and the cutting part 14 are connected to one another in the region of a joint 24 by means of an impact extrusion process the intermediate section 16, which is connected by impact extrusion to the cutting part 14, is further non-releasably connected to the head part 12 in the region of the shank section 22 in the region of a joint 25. The head part 12 and the intermediate section 16 are made of a stainless steel, wherein the cutting part is made of a hardenable material, a cemented carbide, or a technical ceramic.

Since the head part 12 and the intermediate section 16 are preferably made of an identical material, the head part 12 and the intermediate section 16 can be welded together easily and securely in the region of the joint 25.

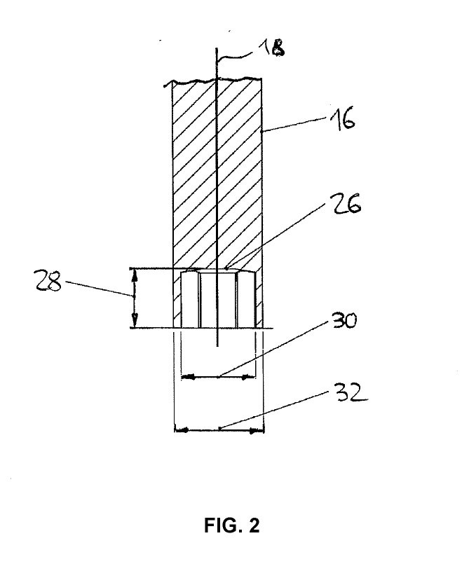

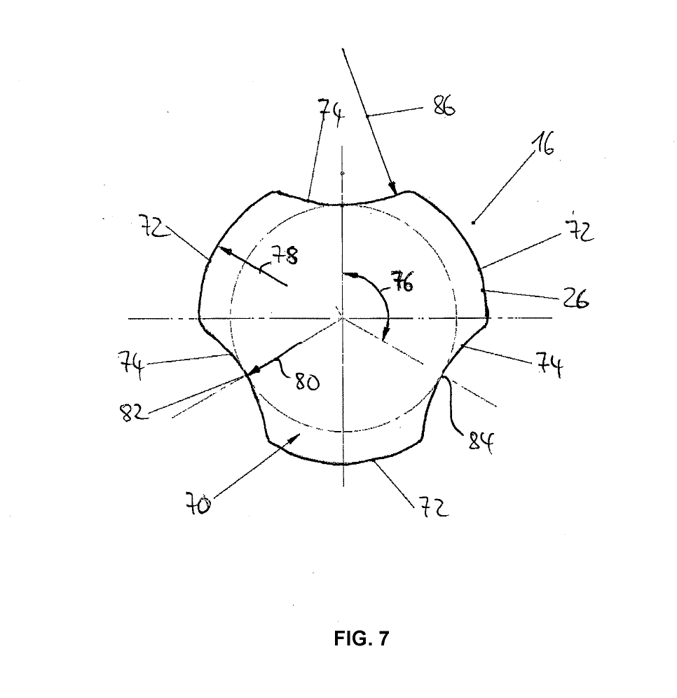

FIG. 2 shows the intermediate section 16 of the drilling screw 10 shown in FIG. 1. The intermediate section 16 is disposed concentrically with the central longitudinal axis 18. The intermediate section 16 comprises a cup-like recess 26. This cup-like recess 26 has a depth 28, which extends in the axial direction, that is, in the direction of the central longitudinal axis 18. The cup-like recess 26 further has a diameter 30 in FIG. 2. The intermediate section 16 is shaped as a circular cylinder and has a diameter 32. The cup-like recess 26 is preferably provided to the intermediate section 16 using a pressing process. Advantageously, the cup-like recess 26 comprises an engagement profile 70 shown in FIG. 7, which will be described and explained in more detail with reference to FIG. 7.

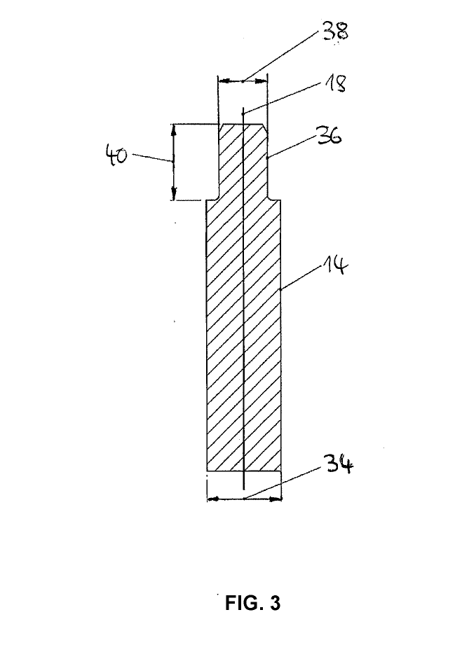

FIG. 3 shows cutting part 14 of the drilling screw 10 shown in FIG. 1. The cutting part 14 has a diameter 34, which approximately corresponds to the diameter 32 of the intermediate section 16. The cutting part 14 comprises a peg-like projection 36. The peg-like projection 36 and the cutting part 14 are aligned concentrically with the central longitudinal axis 18. The cutting part 14 has a diameter 38 in the region of the peg-like projection 36. Furthermore, the peg-like projection 36 has a length 40 in the direction of the central longitudinal axis 18.

The length 40 of the peg-like projection 36 is greater than the depth 28 of the cup-like recess 26 of the intermediate section 16. The diameter 38 of the peg-like projection 36 is smaller than the smallest diameter 30 of the cup-like recess 26.

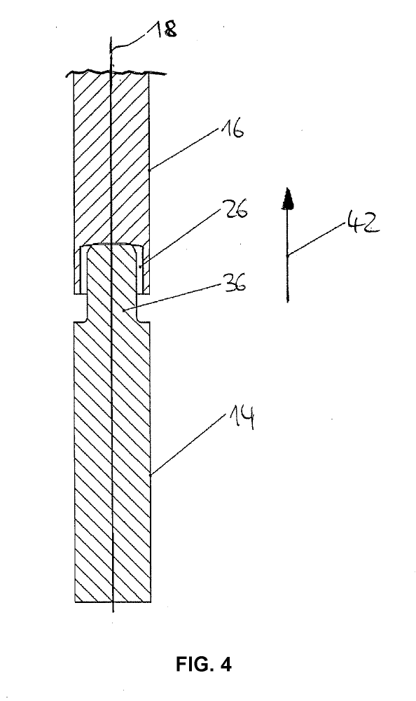

This is clearly visible in FIG. 4. FIG. 4 shows an intermediate section 16 and a cutting part 14, wherein the intermediate section 16 and the cutting part 14 are disposed in axial alignment with the central longitudinal axis 18. The peg-like projection 36 of the cutting part 14 is inserted into the cup-like recess 26 of the intermediate section 16. The peg-like projection 36 can be inserted into the cup-like recess 26 in the direction of the arrow 42. It is clearly visible that the peg-like projection 36 has a length 40 which is greater than the depth 28 of the cup-like recess 26. It is further apparent that the cup-like recess 26 has a greater diameter 30 than the diameter 38 of the peg-like projection 36. FIG. 4 shows the intermediate section 16 and the cutting part 14 prior to performing the impact extrusion process.

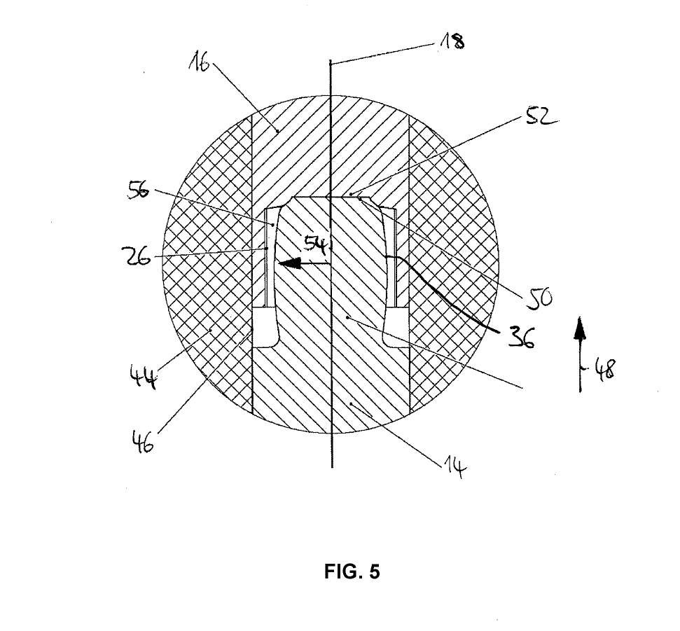

FIG. 5 shows an enlarged part of an intermediate section 16, wherein the peg-like projection 36 of the cutting part 14 is inserted in the cup-like recess 26 of the intermediate section 16. The two parts, that is, the intermediate section 16 and the cutting part 14, are disposed in a die 44 of a multi-stage press and rest against a circumferential surface 46 of the die 44. FIG. 5 shows the intermediate section 16 and the cutting part 14 at the beginning of an impact extrusion process. The operating direction of the machine is indicated by the arrow 48. If the cutting part 14 is moved further in the direction of the arrow 48 beyond the position shown in FIG. 4, an end face 50 of the peg-like projection 36 at least partially penetrates into a bottom surface 52 of the cup-like recess 26. Since further axial deflection in the direction of the arrow 48 is limited by the bottom 52 of the cup-like recess 26, material of the peg-like projection 36 can flow radially outwards, that is, transversely to arrow 48, in the direction of the arrow 54 into a void 56 between the intermediate section 16 and the peg-like projection 36 of the cutting part 14.

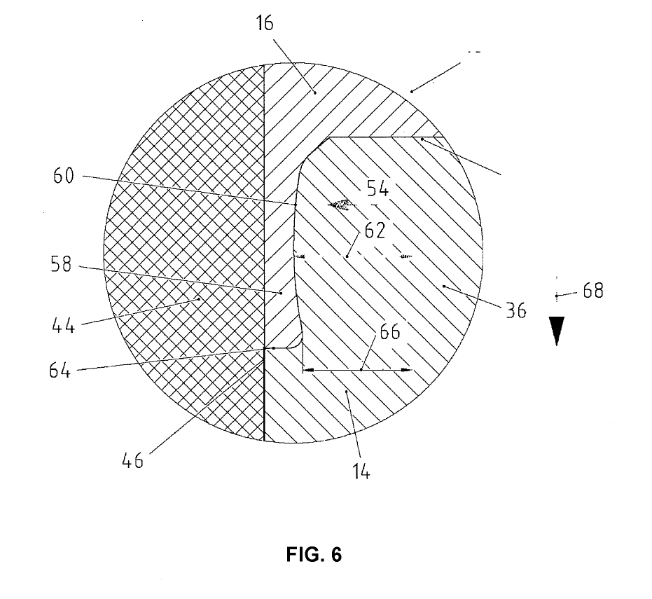

FIG. 6 shows an enlarged part of an impact extruded connection at the end of the impact extrusion process. The intermediate section 16 and the cutting part 14 of the drilling screw 10 are still disposed in the die 44 of a multi-stage press and rest against the circumferential surface 46 of said die. It is clearly visible what the extrusion process in the direction of the arrow 54 causes: Material of the peg-like projection 36 can flow transversely to the operating direction of the press, that is, transversely to the direction indicated by the arrow 48. The material flows into the void 56 shown in FIG. 5 and fills it completely.

Movement of a side wall 58 of the intermediate section 16, which forms the cup-like recess 26, is limited by the circumferential surface 46 of the die 44, since the intermediate section 16 and the cutting part 14 rest against the circumferential surface 46 of the die 44. At the end of the impact extrusion process, the peg-like projection 36 completely fills the cup-like recess 26.

As can be seen in FIG. 6, the peg-like projection 36 then has a bulge 58. The peg-like projection 36 has a diameter 62 in the region of this bulge 60 after the impact extrusion process. The peg-like projection 36 further has a diameter 66 in the transitional area 64 to the peg-like projection 36. The diameter 62 is greater than the diameter 66, such that the peg-like projection 36 undercuts the cup-like recess 26 in the axial direction. Pulling the peg-like projection 36 out of the cup-like recess 26 in the direction of the arrow 68 is thus no longer possible.

Since high torques must also be transmitted when producing bores or when using drilling screws 10, the cup-like recess of the intermediate section 16 comprises an engagement profile 70 shown in FIG. 7, as explained above. The engagement profile 70 is formed by circular segments 72 and engagement sections 74 disposed between said circular segments 72. Three circular segments 72 are provided in FIG. 7, such that these are arranged at an angle 76 of about 120 degrees. In the region of the circular segments 72, the cup-like recess 26 has a radius 78, which is constant in the region of the circular segments 72. In the region of the engagement sections 74, the cup-like recess 26 has a radius 80, which steadily decreases towards the centers 82 of the engagement sections 74. This steadily decreasing radius 80 defines the distance, which decreases in the region of the engagement sections 74. The engagement sections 74 are designed as inverse circular segments and can be defined by a radius 86 applied from outside.

When a cutting part 14 or a peg-like projection 36 of a cutting part 14 is inserted into the cup-like recess 26 of the intermediate section 16 for the impact extrusion process, it is particularly preferred that the diameter 38 of the peg-like projection 36 is selected smaller than, or equal to, the smallest diameter 30 of the cup-like recess 26 in the region of the centers 82 of the engagement sections 74, such that the peg-like projection 36 can easily be inserted into the cup-like recess 26. During the impact extrusion process, the material of the peg-like projection 36 can then deflect into the voids 56, which are defined by the circular segments 72. In addition to the undercuts by the bulge 60, which ensures a connection in the axial direction, torque transmission in the radial direction can be provided due to the engagement profile 70.

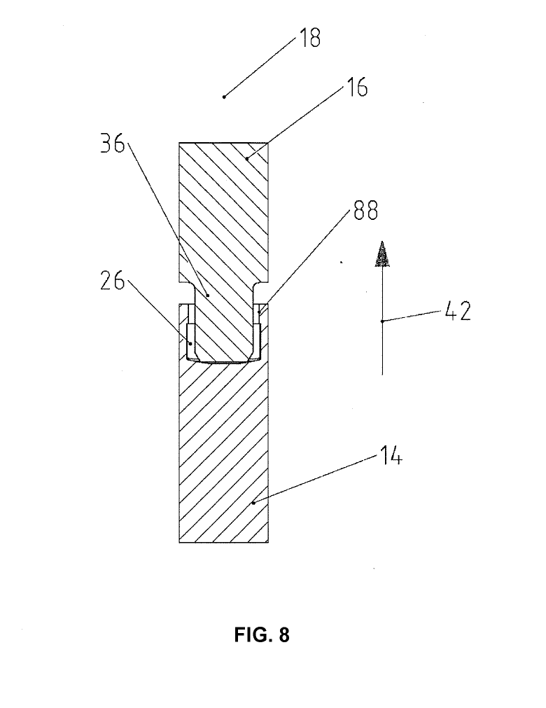

Like the previous explanations and figures, FIGS. 8 to 13 show the various embodiments for cases in which the material of the cutting part 14 cannot be sufficiently formed. In these cases, the filling out is almost exclusively taken over by the intermediate part 16, while the undercuts 88 and 90 on the projection-like peg 36 or in the cup-like recess 26 have already been produced by upstream processes.

FIG. 8 shows the case in which the cup-like recess 26 with engagement profile 70 as well as the undercut 88 are inserted in the cutting part 14. The projection-like peg 36 has a circular cylindrical shape and, as explained above, is longer than the depth of the cup-like recess 26, while its diameter is smaller than, or equal to, the inner diameter of the undercut 88.

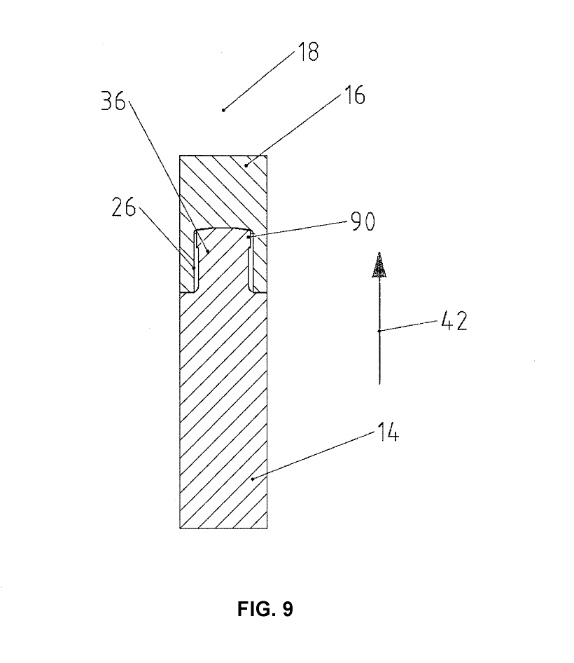

The variant according to FIG. 9 represents a special case, as the manufacturing process of extruding the cup of the intermediate part 16 and pressing together the intermediate part 16 and the cutting part 14 can be performed in one step, depending on the material of the cutting part 14. The forming is in this case performed by the cutting part 14. In addition, the additional material needed for the bulge is provided in this variant by flowing in material from the upper region of the intermediate part 16. The peg-like projection 36 is in this case attached with the engagement profile 70 and undercut 90 to the cutting part 14 in an upstream process.

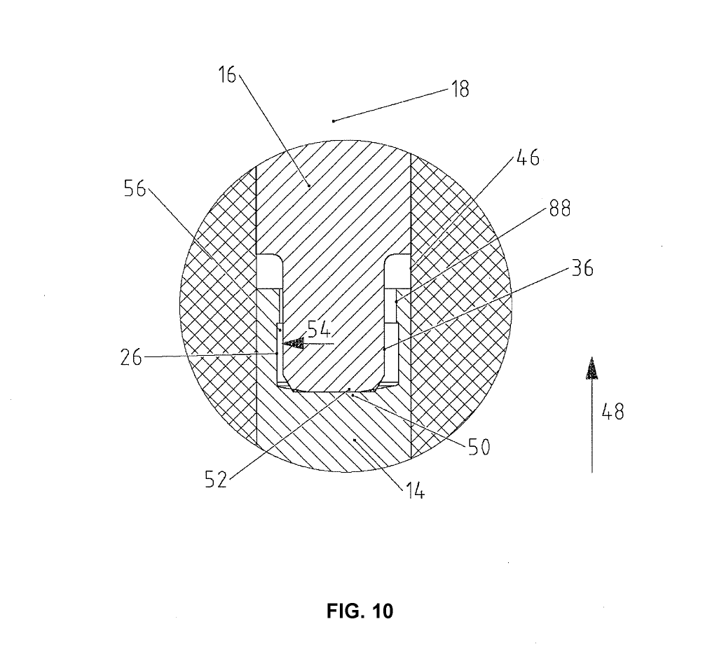

FIG. 10 shows a case like FIG. 5, when the engagement profile 70 and the undercut 88 were previously attached to the cup-like recess 26 on the cutting part 14.

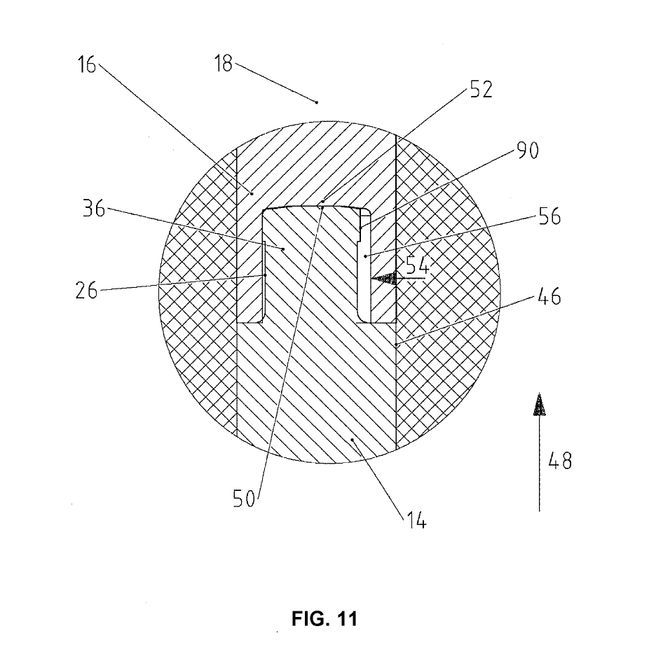

FIG. 11 shows a case like FIG. 5, when the engagement profile 70 and the undercut 90 were previously attached to the peg-like projection 36 of the cutting part 14.

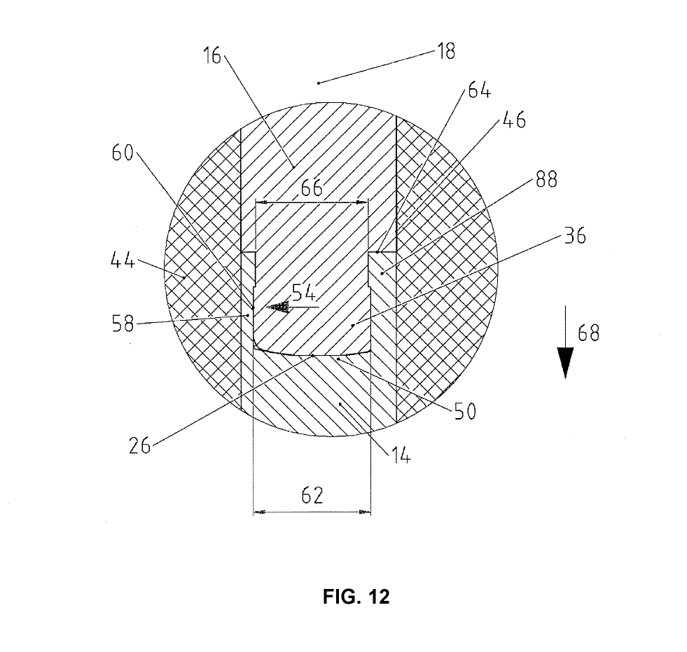

FIG. 12 shows a case like FIG. 6, when the engagement profile 70 and the undercut 88 were previously attached to the cup-like recess 26 on the cutting part 14.

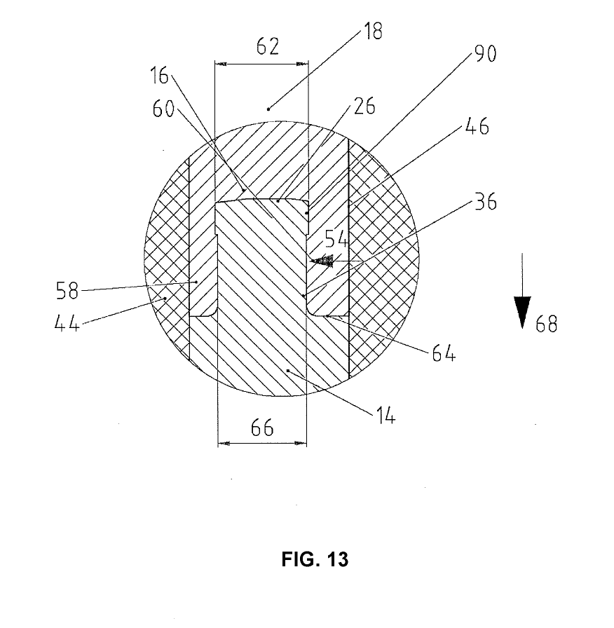

FIG. 13 shows a case like FIG. 6, when the engagement geometry 70 and the undercut 90 were previously attached to the peg-like projection 36 of the cutting part 14.

After connecting the intermediate section 16 and the cutting part 14 by impact extrusion, the intermediate section 16 connected to the cutting part 14 is welded to the head part 12 in the region of the shank section 22.

Since a relatively short intermediate section 16 can be used for impact extrusion, a secure connection of cutting part 14 and intermediate section 16 can be achieved on the one hand, wherein on the other hand a reliable non-releasable connection between the intermediate section 16 and the head part 12 can be produced, since the materials of the intermediate section 16 and the head part 12 are of the same type. The screw length can then preferably be defined by defining the length of the shank section 22 of the head part 12.

What is claimed is:

1. A drilling screw, having a head part and a cutting part, wherein the head part is made of a corrosion-resistant material and comprises a screw head and a shank section, and wherein the cutting part is made of a hardenable material, a cemented carbide, or a technical ceramic, characterized in that an intermediate section made of a corrosion-resistant material is disposed between the shank section and the cutting part, which intermediate section is non-releasably connected to the shank section, wherein the cutting part comprises a peg-like projection or a cup-like recess and wherein the intermediate section comprises a cup-like recess or a peg-like projection, wherein the cup-like recess or a peg-like projection has an engagement profile with multiple engagement sections in its cross section, wherein said peg-like projection is disposed in the cup-like recess and wherein said intermediate section is permanently connected to the cutting part by means of impact extrusion, such that the peg-like projection of the cutting part axially undercuts at least sections of the intermediate section in the region of the cup-like recess or such that the peg-like projection of the intermediate section axially undercuts at least sections of the cutting part in the region of the cup-like recess.

2. The drilling screw according to claim 1, characterized in that the peg-like projection completely fills the cup-like recess or the cup-like recess completely encompasses the peg-like projection.

3. The drilling screw according to claim 1, characterized in that the cutting part is hardened or consists of a hard material and comprises a drill tip.

4. The drilling screw according to claim 3, characterized in that the cutting part comprises a core hole, which leads into the drill tip.

5. The drilling screw according to claim 1, characterized in that the cutting part is made of materials selected from the following group: a high-speed steel (HSS), a heat-treated steel, a cemented carbide, and a technical ceramic.

6. The drilling screw according to claim 1, characterized in that the head part and the intermediate section are made of a stainless steel.

7. The drilling screw according to claim 1, characterized in that the engagement profile is designed as one of the following: a Torx, Torx plus, hexagon, multi-tooth, gearing, and a cross.

8. A method for manufacturing a drilling screw, comprising a head part made of a corrosion-resistant material and having a screw head and a shank section, a cutting part made of a hardenable or hard material, and an intermediate section (16) made of a corrosion-resistant material and disposed between the shank section and the cutting part, the method comprising the following steps:
Pressing a cup-like recess of a predetermined depth into the intermediate section or molding a peg-like projection of a predetermined length onto the intermediate section;
Producing the cutting part with a peg-like projection or pressing in a cup-like recess into the cutting part; wherein an engagement profile with engagement sections is pressed in or molded on during pressing in the cup-like recess or the peg-like projection;
Inserting the projection into the recess and connecting the intermediate section and the cutting part by means of impact extrusion, such that the peg-like projection completely fills out the cup-like recess or the peg-like projection is completely encompassed by the cup-like recess;
Welding together the shank section and the intermediate section connected to the cutting part.

9. The method according to claim 8, characterized in that the cup-like recess is pressed into the intermediate section or into the cutting part at an area ratio of about 20% to about 75% relative to the cross-sectional area of the intermediate section.

10. The method according to claim 8, characterized in that the peg-like projection is produced in a circular cylindrical shape or with an engagement profile.

11. The method according to claim 8, characterized in that the intermediate section and the cutting part are brought into axial alignment before being connected.

12. The method according to claim 8, characterized in that the shank section and the intermediate section which is connected to the cutting part are brought into axial alignment before being connected.

13. The method according to claim 8, characterized in that the shank section, the intermediate section, and the cutting part are rolled straight after welding and a thread is then rolled onto the shank section, the intermediate section, and the cutting part.

14. The method according to claim 8, characterized in that manufacturing the cutting part or manufacturing the intermediate section and connecting with the intermediate section or cutting part are performed in a multi-stage press.
